(19) United States
(12) Patent Application Publication
(10) Pub. No.: US 2022/0168182 A1
(43) Pub. Date: Jun. 2, 2022

(54) ULTRASONIC DEVICE AND CONTROL METHOD THEREOF

(71) Applicant: INDUSTRIAL TECHNOLOGY RESEARCH INSTITUTE, Hsinchu (TW)

(72) Inventors: Chun-Jung Chen, Hsinchu (TW); Ken-Tsu Hu, Hsinchu (TW); Kuo-Chun Lee, Hsinchu (TW)

(21) Appl. No.: 17/106,394

(22) Filed: Nov. 30, 2020

(51) Int. Cl. A61H 39/00

(52) U.S. Cl. CPC A61H 39/007; A61H 2201/10

(57) ABSTRACT

An ultrasonic device is provided and includes a base having an action portion, and a plurality of action members arranged on the action portion of the base for providing ultrasonic waves. The ultrasonic waves generated by the plurality of action members focus at different target positions so as to generate an acupuncture effect without invading into a human body during an acupuncture operation.

### BACKGROUND

### 1. Technical Field

The present disclosure relates to ultrasonic devices, and more particularly, to an ultrasonic device and an ultrasonic control method applicable to an acupuncture operation.

### 2. Description of Related Art

Acupuncture is a common treatment in traditional Chinese medicine, which needs to insert a needle into an effective position of a human body. Therefore, acupuncture is an invasive treatment for the human body and poses a challenge to a doctor's experience and skill.

Since acupuncture is an invasive treatment for the human body, the use of a needle brings strong stimulation, pain and even a risk of infection due to skin puncture. Further, different acupuncture methods required at different acupoints increase the technical difficulty, which not only increases the risk of acupuncture injury and needle breakage, but also makes it difficult for another doctor to imitate the experience and skill of a skilled doctor.

Moreover, since it is not easy to imitate the experience and skill of a skilled doctor, people need to visit specific places (e.g., specific clinics or hospitals) for acupuncture treatment. Consequently, it is especially difficult for people with mobility difficulties to get acupuncture treatment.

Therefore, how to overcome the above-described drawbacks of the prior art has become an urgent issue in the art.

### SUMMARY

In view of the above-described drawbacks, the present disclosure provides an ultrasonic device, which comprises: a base having an action portion; and a plurality of action members arranged on the action portion for providing ultrasonic waves, wherein the ultrasonic waves generated by the plurality of action members focus at different target positions.

The present disclosure further provides a method of controlling ultrasonic, which comprises: providing the ultrasonic device as described above; emitting ultrasonic waves by the plurality of action members; and focusing the ultrasonic waves generated by the action members at different target positions.

According to the ultrasonic device and the ultrasonic control method of the present disclosure, the ultrasonic waves generated by the plurality of action members focus at different target positions so as to generate an acupuncture effect without invading into a human body. That is, the acupuncture operation is not invasive. Compared with the prior art, the acupuncture operation performed by the ultrasonic device and the ultrasonic control method of the present disclosure has low stimulation and is painless for the human body and prevents the risk of infection due to the absence of a wound.

Further, the action portion of the base can be properly designed in conjunction with an acupoint of the human body such that the ultrasonic waves generated by the action members can easily focus at predetermined target positions. Therefore, compared with the prior art, the ultrasonic device of the present disclosure can use the same method for different acupoints, thus greatly reducing the difficulty of the acupuncture operation, eliminating the need of experience and skill of doctors and preventing the risk of acupuncture injury and needle breakage.

Furthermore, by dispensing with the experience and skill of doctors, the ultrasonic device and the ultrasonic control method of the present disclosure can perform an acupuncture operation immediately. Therefore, compared with the prior art, a person, especially one with mobility difficulties (e.g., a disabled person), can use the ultrasonic device of the present disclosure to perform an acupuncture operation at any time without having to go to a specific place (e.g., a Chinese medicine clinic).

### BRIEF DESCRIPTION OF THE DRAWINGS

FIG. 1A is a schematic perspective exploded view of an ultrasonic device according to a first embodiment of the present disclosure.

FIG. 1A′ is a schematic perspective view showing various aspects of an action member of the ultrasonic device according to the present disclosure.

FIG. 1A″ is a schematic side view showing an action mode of the action member of the ultrasonic device according to the present disclosure.

FIG. 1B is a schematic side view showing configuration of the action members of FIG. 1A.

FIG. 1C is a schematic upper view of the configuration of the action members of FIG. 1A.

FIG. 1D is a schematic side view showing another aspect of FIG. 1B.

FIG. 2A is a schematic side view showing configuration of the action members of the ultrasonic device according to a second embodiment of the present disclosure.

FIG. 2B is a schematic upper view of the configuration of the action members of the ultrasonic device according to the second embodiment of the present disclosure.

FIG. 3A is a schematic side view showing configuration of the action members of the ultrasonic device according to a third embodiment of the present disclosure.

FIG. 3B is a schematic upper view of the configuration of the action members of the ultrasonic device according to the third embodiment of the present disclosure.

FIG. 4 is a schematic perspective view showing application of the ultrasonic device according to the present disclosure.

### DETAILED DESCRIPTION

The following illustrative embodiments are provided to illustrate the present disclosure, these and other advantages and effects can be apparent to those in the art after reading this specification.

It should be noted that all the drawings are not intended to limit the present disclosure. Various modifications and variations can be made without departing from the spirit of the present disclosure. Further, terms such as “first,” “second,” “third,” “fourth,” “a,” etc., are merely for illustrative purposes and should not be construed to limit the scope of the present disclosure.

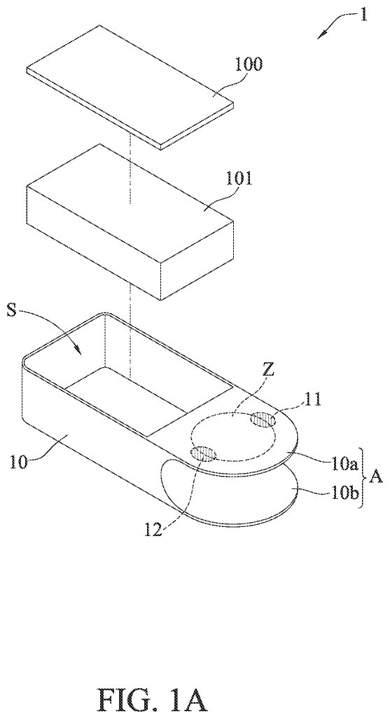

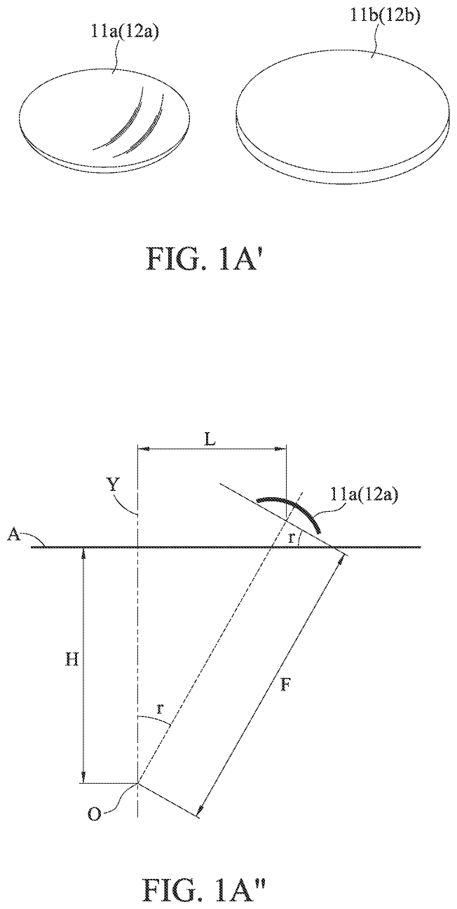

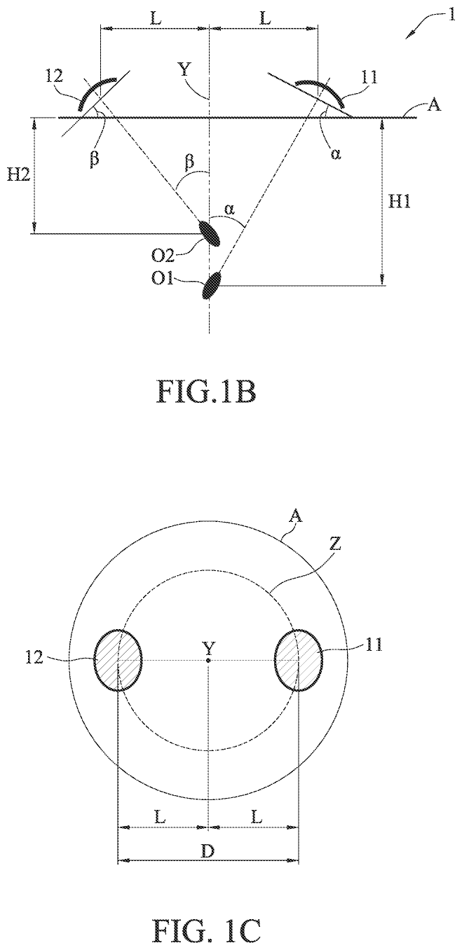

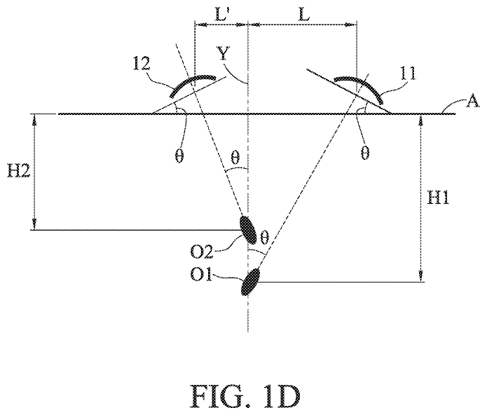

FIG. 1A is a schematic perspective exploded view of an ultrasonic device according to a first embodiment of the present disclosure. Referring to FIG. 1A, an ultrasonic device 1 is used for generating an acupuncture function and comprises a base 10 and a first action member 11 and a second action member 12 arranged on the base 10. The action members are such as ultrasonic piezoelectric sheets.

The base 10 has an action portion A for arranging the first action member 11 and the second action member 12.

In an embodiment, one side of the base 10 has two sheets 10a, 10b, which are spaced from one another so as to form a clamping probe serving as the action portion A. For example, a target object 9 can be embedded between the two sheets 10a, 10b (as shown in FIG. 4) so as for the first action member 11 and the second action member 12 to act on the target object 9. In an embodiment, the target object 9 is a palm of a human body, and the portion between the thumb and index finger is embedded between the two sheets 10a, 10b. It should be understood that the base can be designed in conjunction with the profile of the target object so as to facilitate an acupuncture operation of the ultrasonic device on the target object.

Further, at least one sheet 10a of the action portion A is defined with such as a circular configuration region Z for positioning the first action member 11 and the second action member 12 thereon.

The other side of the base 10 has an accommodating space S for placing a circuit board 100 and a battery 101. The circuit board 100 is electrically connected to the first action member 11 and the second action member 12, and the battery 101 supplies power to the circuit board 100, the first action member 11 and the second action member 12. For example, the circuit board 100 can be configured with a Bluetooth control chip, an ultrasonic transmitting circuit, a control system circuit or an intelligent control system according to the practical need.

The first action member 11 is an ultrasonic element such as an ultrasonic piezoelectric sheet, which is arranged on the configuration region Z of the action portion A and generates low energy suitable for the human body.

In an embodiment, referring to FIG. 1A′, the first action member 11 is a focusing type piezoelectric sheet 11a or a planar type piezoelectric sheet 11b, which is arranged on an edge line of the circular configuration region Z. But it should be understood that the type and structure of the ultrasonic piezoelectric sheet can be varied and not limited thereto.

Further, referring to FIG. 1A″ (in which the focusing type piezoelectric sheet 11a is used as an example), the linear length between the focusing type piezoelectric sheet 11a and a target position O at which ultrasonic waves generated by the focusing type piezoelectric sheet 11a relative to the surface of the action portion A focus (i.e., the place where the action member intends to generate an acupuncture effect) is defined as a focusing distance F, and the linear length between the target position O and the surface of the action portion A is defined as an action distance H (i.e., supposing the puncture length of the needle is 15 to 25 mm). Therein, the target position O is located on an action axis Y of the configuration region Z of the action portion A (i.e., the supposed acupuncture, for example, the axis at the center of the circular configuration region Z). Therefore, the action distance H can be adjusted by adjusting the focusing distance F, as shown in the following table.

| H (mm) | L (mm) | r (angle) | F (mm) |
|---|---|---|---|
| 15 | 10 | 33 | 18.4 |
| 25 | 10 | 22 | 26.7 |

Therein, the radius of the configuration region Z of the action portion A (i.e., the distance between the position of the action member and the action axis Y) is defined as a mounting distance L, and an angle r is defined between the focusing direction of the action member and the action axis Y (i.e., a mounting angle of the action member). It can be understood that, if the mounting distance L is constant, the action distance H can be adjusted by adjusting the angle r (or the mounting angle) Similarly, if the angle r (or the mounting angle) is constant, the action distance H can be adjusted by adjusting the mounting distance L.

Further, the circuit board 100 drives the first action member 11 to generate ultrasonic energy.

The second action member 12 is an ultrasonic element such as an ultrasonic piezoelectric sheet, which is arranged on the edge line of the configuration region Z of the action portion A and generates low energy suitable for the human body.

In an embodiment, referring to FIG. 1A′, the second action member 12 is a focusing type piezoelectric sheet 12a or a planar type piezoelectric sheet 12b. For example, both the first action member 11 and the second action member 12 are focusing type piezoelectric sheets 11a, 12a, or both the first action member 11 and the second action member 12 are planar type piezoelectric sheets 11b, 12b. Alternatively, one of the first action member 11 and the second action member 12 is a focusing type piezoelectric sheet 11a, 12a, and the other is a planar type piezoelectric sheet 11b, 12b. It should be understood that the types and structures of the ultrasonic piezoelectric sheets can be varied and not limited thereto.

Further, the action mode of the second action member 12 is identical to that of the first action member 11, as shown in FIGS. 1A″ and 1B. By adjusting the action distance H, the target position O2 of the second action member 12 can be different from the target position O1 of the first action member 11. For example, referring to FIG. 1C, the second action member 12 and the first action member 11 are arranged on opposite ends of a diameter D of the configuration region Z of the action portion A, respectively. That is, the second action member 12 and the first action member 11 have the same mounting distance L. Therefore, by adjusting the mounting angle β of the second action member 12 (which is different from the mounting angle α of the first action member 11), the action distance H2 of the second action member 12 is different from the action distance H1 of the first action member 11, and the target position O2 of the second action member 12 is different from the target position O1 of the first action member 11.

Alternatively, referring to FIG. 1D, if the first action member 11 and the second action member 12 have the same mounting angle θ, by adjusting the mounting distance L′ of the second action member 12 (or the mounting distance L of the first action member 11), the action distance H2 of the second action member 12 is different from the action distance H1 of the first action member 11, and the target position O2 of the second action member 12 is different from the target position O1 of the first action member 11.

Furthermore, the circuit board 100 drives the second action member 12 to generate ultrasonic energy. For example, the circuit board 100 can drive the first action member 11 and the second action member 12 in sequence, and the circuit board 100 can adjust the driving times for the first action member 11 and the second action member 12. Alternatively, the circuit board 100 can drive the first action member 11 and the second action member 12 at the same time.

In use of the ultrasonic device 1, the first action member 11 and the second action member 12 emit ultrasonic waves to a target object 9, and the ultrasonic waves generated by the first action member 11 and the second action member 12 focus at different target positions O1, O2 of the target object 9. Therein, if the circuit board 100 drives in the sequence of the first action member 11 and the second action member 12, a needle pulling (needle withdrawing) effect is generated. On the other hand, if the circuit board 100 drives in the sequence of the second action member 12 and the first action member 11, a needle pushing (needle inserting) effect is generated.

According to the ultrasonic control method of the ultrasonic device 1 of the present disclosure, further referring to FIG. 4, the ultrasonic waves generated by the first action member 11 and the second action member 12 focus at different target positions O1, O2 to generate an acupuncture effect during an acupuncture operation. Therefore, the base 10 can be properly designed in conjunction with an acupoint of the human body so as to facilitate the acupuncture operation of the ultrasonic device 1 on the human body. For example, if the target object 9 is a palm of the human body, through the design of the two sheets 10a, 10b, the portion between the thumb and index finger can be embedded in the base 10 so as to cause the action axis Y to be aligned with Hegu acupoint 8. As such, the first action member 11 and the second action member 12 can perform an acupuncture operation on Hegu acupoint 8 for relieving symptoms of motion sickness.

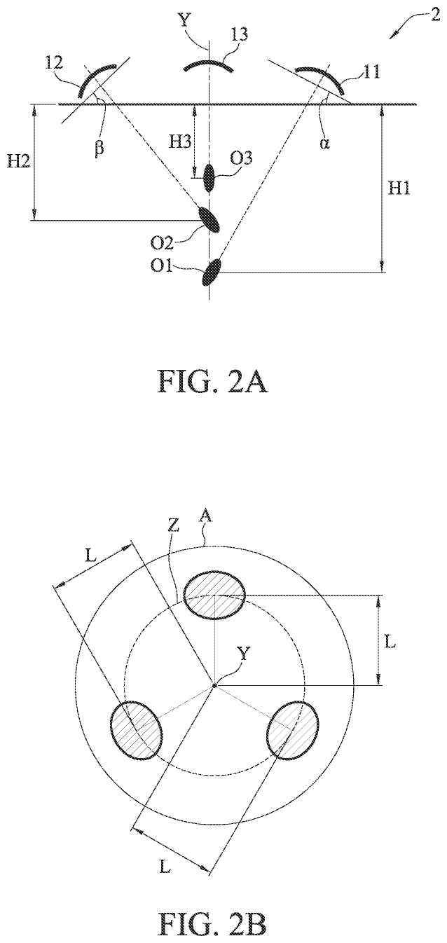

FIGS. 2A and 2B are schematic diagrams showing an ultrasonic device 2 according to a second embodiment of the present disclosure. The second embodiment differs from the first embodiment in the number of the action members, and the same or similar structures will not be repeated.

Referring to FIGS. 2A and 2B, the ultrasonic device 2 further comprises a third action member 13 arranged on the base 10. For example, the third action member 13 is arranged on the configuration region Z of the action portion A and generates low energy suitable for the human body.

In an embodiment, the third action member 13 is an ultrasonic element such as an ultrasonic piezoelectric sheet, and the type of the third action member 13 can be identical to or different from those of the first action member 11 and the second action member 12.

Further, the action mode of the third action member 13 is identical to that of the first action member 11. Referring to FIG. 2B, since the three action members have the same mounting distance L, by adjusting the mounting angle of the third action member 13 (omitting the perspective factor of FIG. 2A, the mounting angle of the third action member 13 is different from the mounting angle α of the first action member 11 and the mounting angle (3 of the second action member 12), the action distances H1, H2 and H3 are different from one another, as shown in FIG. 2A, and the target position O3 of the third action member 13 is different from the target positions O1, O2 of the first and second action members 11, 12.

Furthermore, the circuit board 100 drives the third action member 13 to generate ultrasonic energy. The circuit board 100 can drive the first action member 11, the second action member 12 and the third action member 13 separately (i.e., not at the same time), and the circuit board 100 can also adjust the driving time for the third action member 13. Alternatively, the circuit board 100 can drive the first action member 11, the second action member 12 and the third action member 13 at the same time, or arbitrarily set the driving sequence of the first action member 11, the second action member 12 and the third action member 13.

In addition, the first action member 11, the second action member 12 and the third action member 13 can be arranged equidistantly along the edge line of the configuration region Z, as shown in FIG. 2B.

In use of the ultrasonic device 2, the first to third action members 11, 12, 13 emit ultrasonic waves to a target object 9 (as shown in FIG. 4), and the ultrasonic waves generated by the first to third action members 11, 12, 13 focus at different target positions O1, O2, O3 of the target object 9. Therein, if the circuit board 100 drives in the sequence of the first action member 11, the second action member 12 and the third action member 13, a needle pulling effect is generated. On the other hand, if the circuit board 100 drives in the sequence of the third action member 13, the second action member 12 and the first action member 11, a needle pushing effect is generated.

Therefore, according to the ultrasonic control method of the ultrasonic device 2 of the present disclosure, the ultrasonic waves generated by the first to third action members 11, 12, 13 focus at different target positions O1, O2, O3 to generate an acupuncture effect during an acupuncture operation. Therefore, the base 10 can be properly designed in conjunction with an acupoint of the human body so as to facilitate the acupuncture operation of the ultrasonic device 2 on the human body.

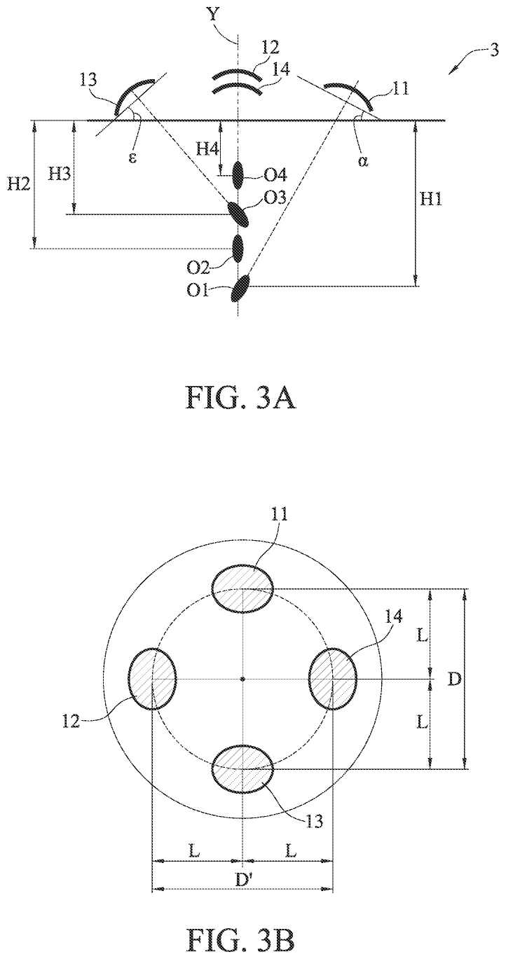

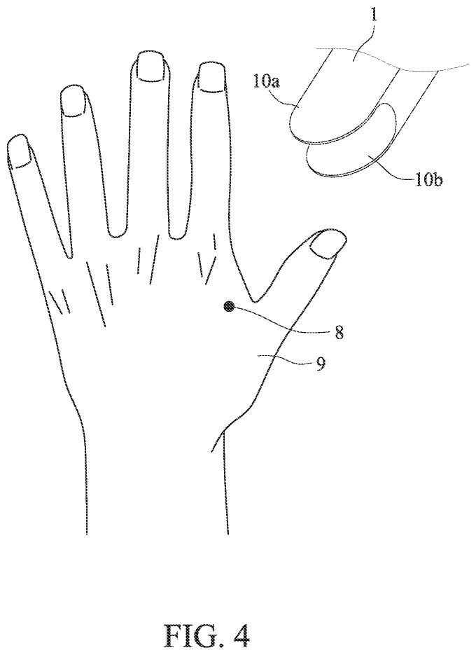

FIGS. 3A and 3B are schematic diagrams showing an ultrasonic device 3 according to a third embodiment of the present disclosure. The third embodiment differs from the second embodiment in the number of the action members, and the same or similar structures will not be repeated.

Referring to FIGS. 3A and 3B, the ultrasonic device 3 further comprises a fourth action member 14 arranged on the base 10. For example, the fourth action member 14 is arranged on the configuration region Z of the action portion A and generates low energy suitable for the human body.

In an embodiment, the fourth action member 14 is an ultrasonic element such as an ultrasonic piezoelectric sheet, and the type of the fourth action member 14 can be identical to or different from those of the first to third action members 11, 12, 13.

Further, the action mode of the fourth action member 14 is identical to that of the first action member 11. Referring to FIG. 3B, since the four action members have the same mounting distance L, by adjusting the mounting angle of the fourth action member 14 (omitting the perspective factor of FIG. 3A, the mounting angle of the fourth action member 14 is different from the mounting angle α of the first action member 11, the mounting angle β of the second action member 12 and the mounting angle ε of the third action member 13), the action distances H1, H2, H3 and H4 are different from one another, as shown in FIG. 3A, and the target position O4 of the fourth action member 14 is different from the target positions O1, O2, O3 of the first to third action members 11, 12, 13.

Furthermore, the circuit board 100 drives the fourth action member 14 to generate ultrasonic energy. The circuit board 100 can drive the first action member 11, the second action member 12, the third action member 13 and the fourth action member 14 separately (i.e., not at the same time), and the circuit board 100 can also adjust the driving time for the fourth action member 14. Alternatively, the circuit board 100 can drive the first action member 11, the second action member 12, the third action member 13 and the fourth action member 14 at the same time, or arbitrarily set the driving sequence of the first action member 11, the second action member 12, the third action member 13 and the fourth action member 14.

In addition, the first action member 11, the second action member 12, the third action member 13 and the fourth action member 14 can be arranged equidistantly along the edge line of the configuration region Z, as shown in FIG. 3B. For example, the first action member 11 and the third action member 13 are arranged on opposite ends of a diameter D of the configuration region Z of the action portion A, respectively. That is, the first action member 11 and the third action member 13 have the same mounting distance L. Further, the second action member 12 and the fourth action member 14 are arranged on opposite ends of a diameter D′ of the configuration region Z of the action portion A, respectively, and the diameter D′ is perpendicular to the diameter D.

In use of the ultrasonic device 3, the first to fourth action members 11, 12, 13, 14 emit ultrasonic waves to a target object 9, and the ultrasonic waves generated by the first to fourth action members 11, 12, 13, 14 focus at different target positions O1, O2, O3, O4 of the target object 9. Therein, if the circuit board 100 drives in the sequence of the first action member 11, the second action member 12, the third action member 13 and the fourth action member 14, a needle pulling effect is generated. On the other hand, if the circuit board 100 drives in the sequence of the fourth action member 14, the third action member 13, the second action member 12 and the first action member 11, a needle pushing effect is generated.

Therefore, according to the ultrasonic control method of the ultrasonic device 3 of the present disclosure, the ultrasonic waves generated by the first to fourth action members 11, 12, 13, 14 focus at different target positions O1, O2, O3, O4 to generate an acupuncture effect during an acupuncture operation. Therefore, the base 10 can be properly designed in conjunction with an acupoint of the human body so as to facilitate the acupuncture operation of the ultrasonic device 3 on the human body.

According to the ultrasonic device and the ultrasonic control method of the present disclosure, the ultrasonic waves generated by the action members focus at different target positions so as to generate an acupuncture effect without invading into the human body. That is, the acupuncture operation is not invasive. Compared with the prior art, the acupuncture operation performed by the ultrasonic device and the ultrasonic control method of the present disclosure has low stimulation and is painless for the human body and prevents the risk of infection due to the absence of a wound.

Further, the action portion of the base can be properly designed in conjunction with an acupoint of the human body such that the ultrasonic waves generated by the action members can easily focus at predetermined target positions. Therefore, compared with the prior art, the ultrasonic device of the present disclosure can use the same method for different acupoints, thus simplifying the acupuncture operation, eliminating the need of experience and skill of doctors and preventing the risk of acupuncture injury and needle breakage.

Furthermore, since the ultrasonic device and the ultrasonic control method of the present disclosure eliminates the need of imitating experience and skill of doctors and the ultrasonic device of the present disclosure can be light and portable so as to allow an acupuncture operation to be performed immediately, a person, especially one with mobility difficulties (e.g., a disabled person), can use the ultrasonic device of the present disclosure to perform an acupuncture operation at any time without having to go to a specific place (e.g., a Chinese medicine clinic).

The above-described descriptions of the detailed embodiments are to illustrate the preferred implementation according to the present disclosure, and it is not to limit the scope of the present disclosure. Accordingly, all modifications and variations completed by those with ordinary skill in the art should fall within the scope of present disclosure defined by the appended claims.

What is claimed is:

1. An ultrasonic device, comprising:
a base having an action portion; and
a plurality of action members arranged on the action portion for providing ultrasonic waves, wherein the ultrasonic waves generated by the plurality of action members focus at different target positions.

2. The ultrasonic device of claim 1, further comprising a circuit board arranged on the base and electrically connected to the plurality of action members.

3. The ultrasonic device of claim 2, wherein the circuit board drives at least two of the plurality of action members separately.

4. The ultrasonic device of claim 2, wherein the circuit board drives at least two of the plurality of action members simultaneously.

5. The ultrasonic device of claim 1, wherein the action members are ultrasonic piezoelectric sheets.

6. The ultrasonic device of claim 1, wherein mounting angles of the plurality of action members on the action portion are different from one another.

7. The ultrasonic device of claim 1, wherein linear lengths between the target positions and the action members are defined as focusing distances, and the focusing distances are identical.

8. The ultrasonic device of claim 1, wherein linear lengths between the target positions and the action members are defined as focusing distances, and the focusing distances are different from one another.

9. The ultrasonic device of claim 1, wherein the action portion is defined with an action axis, and mounting distances between the action axis and the action members are identical.

10. The ultrasonic device of claim 1, wherein the action portion is defined with an action axis, and mounting distances between the action axis and at least two of the plurality of action members are different from one another.

11. A method of controlling ultrasonic, comprising:
providing the ultrasonic device of claim 1;
emitting ultrasonic waves by the plurality of action members; and
focusing the ultrasonic waves generated by the action members at different target positions.

12. The method of claim 11, wherein a circuit board is arranged on the base and electrically connected to the plurality of action members.

13. The method of claim 12, wherein the circuit board drives at least two of the plurality of action members separately.

14. The method of claim 12, wherein the circuit board drives at least two of the plurality of action members simultaneously.

15. The method of claim 11, wherein the action members are ultrasonic piezoelectric sheets.

16. The method of claim 11, wherein mounting angles of the plurality of action members on the action portion are different from one another.

17. The method of claim 11, wherein linear lengths between the target positions and the action members are defined as focusing distances, and the focusing distances are identical.

18. The method of claim 11, wherein linear lengths between the target positions and the action members are defined as focusing distances, and the focusing distances are different from one another.

19. The method of claim 11, wherein the action portion is defined with an action axis, and mounting distances between the action axis and the action members are identical.

20. The method of claim 11, wherein the action portion is defined with an action axis, and mounting distances between the action axis and at least two of the plurality of action members are different from one another.
